(19) United States
(12) Patent Application Publication
(10) Pub. No.: US 2012/0247422 A1
(43) Pub. Date: Oct. 4, 2012

(54) CONTROL DEVICE AND CONTROL METHOD FOR INTERNAL COMBUSTION ENGINE

(75) Inventor: Keisuke Nagakura, Toyota-shi (JP)

(73) Assignee: TOYOTA JIDOSHA KABUSHIKI KAISHA, Toyota-shi (JP)

(21) Appl. No.: 13/432,450

(22) Filed: Mar. 28, 2012

(30) Foreign Application Priority Data
Apr. 4, 2011 (JP) 2011-082589

(51) Int. Cl. F02B 5/02

(52) U.S. Cl. 123/299

(57) ABSTRACT

A control device for an internal combustion engine in which a direct injector that directly injects fuel into a corresponding one of a plurality of cylinders and a port injector that injects fuel into an intake port are both provided on each of the plurality of cylinders includes: a control unit that controls a fuel injection amount from the direct injectors and the port injectors; and an imbalance detecting unit that, in a state where fuel is injected from both of the direct injectors and the port injectors, detects an imbalance in air-fuel ratio among the plurality of cylinders. When the imbalance in air-fuel ratio is detected by the imbalance detecting unit, the control unit controls the fuel injection amount from the direct injectors and the port injectors such that fuel is injected from one of the direct injectors and the port injectors.

### INCORPORATION BY REFERENCE

The disclosure of Japanese Patent Application No. 2011-082589 filed on Apr. 4, 2011 including the specification, drawings and abstract is incorporated herein by reference in its entirety.

### BACKGROUND OF THE INVENTION

1. Field of the Invention

The invention relates to a control device and control method for an internal combustion engine and, more particularly, to a control device and control method that control an internal combustion engine in which a direct injector that directly injects fuel into a corresponding one of a plurality of cylinders and a port injector that injects fuel into an intake port are provided in correspondence with each of the plurality of cylinders.

2. Description of Related Art

For an internal combustion engine controlled by a control device, particularly, there is known an internal combustion engine in which a direct injector that directly injects fuel into a corresponding one of a plurality of cylinders and a port injector that injects fuel into an intake port are provided in correspondence with each of the plurality of cylinders. In such an internal combustion engine, the air-fuel ratio of any one of the cylinders can differ from the air-fuel ratio of each of the other cylinders because of an abnormality of at least any one of the direct injector and the port injector.

Incidentally, in a state where fuel is injected from both the direct injector and the port injector, it is difficult to identify which injector has an abnormality. In consideration of the above problem, Japanese Patent Application Publication No. 2010-169038 (JP 2010-169038 A) describes a technique that, in a port injection mode in which fuel is injected from only port injection valves, a port deviation accumulated value that is obtained by accumulating a deviation between an output value of a downstream air-fuel ratio sensor and a target output value corresponding to a stoichiometric air-fuel ratio is calculated, and, in a direct injection mode in which fuel is injected from only direct injection valves, an in-cylinder deviation accumulated value that is obtained by accumulating a deviation between an output value of the air-fuel ratio sensor and a target value. In the direct injection mode, the above technique fixes the selection mode in the direct injection mode when it may be determined that there is an imbalance in air-fuel ratio among the cylinders on the basis of the in-cylinder deviation accumulated value and the port deviation accumulated value.

However, in the technique described in JP 2010-169038 A, before it is determined to fix the injection mode in the direct injection mode, it is necessary to calculate a deviation accumulated value both in the port injection mode in which fuel is injected from only the port injection valves and in the direct injection mode in which fuel is injected from only the direct injection valves. Thus, it requires a long period of time to fix the injection mode and then identify which injector has an abnormality. Particularly, when fuel injection from one of the two types of injectors is stopped, a deposit easily accumulates in that injectors, so it is not desirable to increase a period of time during which fuel is injected from only one of the two types of injectors. Particularly, a deposit easily accumulates in the direct injectors, so the frequency at which fuel injection from the direct injectors is stopped and fuel is injected from only the port injectors is not so high. As a result, there may be a case where the port deviation accumulated value cannot be calculated, so it may be impossible to calculate an imbalance in air-fuel ratio.

### SUMMARY OF THE INVENTION

The invention provides a control device and control method for an internal combustion engine, which early identifies which injectors have an abnormality.

A first aspect of the invention relates to a control device for an internal combustion engine in which a direct injector that directly injects fuel into a corresponding one of a plurality of cylinders and a port injector that injects fuel into an intake port are both provided on each of the plurality of cylinders. The control device includes: a control unit that controls a fuel injection amount from the direct injectors and the port injectors; and an imbalance detecting unit that, in a state where fuel is injected from both of the direct injectors and port injectors, detects an imbalance in air-fuel ratio among the plurality of cylinders. When the imbalance in air-fuel ratio is detected by the imbalance detecting unit, the control unit controls the fuel injection amount from the direct injectors and the port injectors such that fuel is injected from one of the direct injectors and the port injectors.

According to the above aspect, when the imbalance in air-fuel ratio among the cylinders is detected in a state where fuel is injected from both of the direct injectors and the port injectors, the control unit injects fuel from one of the direct injectors and the port injectors and stops fuel injection from the other one. Here, when the fuel injection from one of the two types of injectors is stopped, inconvenience, such as accumulation of a deposit, may occur, so there are more opportunities to acquire the air-fuel ratio in the case where fuel is injected from both of the direct injectors and the port injectors than opportunities to acquire the air-fuel ratio in both cases, that is, the case where fuel is injected from only the direct injectors and the case where fuel is injected from only the port injectors. Thus, when either the direct injectors or the port injectors have an abnormality, the imbalance in air-fuel ratio may be quickly detected to proceed to a state where fuel is injected from one of the direct injector and the port injector. When the imbalance in air-fuel ratio has also been detected in a state where fuel is injected from one of the direct injectors and the port injectors, it may be identified that the injectors that inject fuel have an abnormality; whereas, when the imbalance is not detected, it may be identified that the injectors of which fuel injection is stopped have an abnormality. As a result, it is possible to early identify injectors have an abnormality.

A second aspect of the invention relates to a control method for an internal combustion engine in which a direct injector that directly injects fuel into a corresponding one of a plurality of cylinders and a port injector that injects fuel into an intake port are both provided on each of the plurality of cylinders. The control method includes: in a state where fuel is injected from both of the direct injectors and the port injectors, detecting an imbalance in air-fuel ratio among the plurality of cylinders; and, when the imbalance in air-fuel ratio is detected, controlling a fuel injection amount from the direct injectors and the port injectors such that fuel is injected from one of the direct injectors and the port injectors.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram that shows a power train of a hybrid vehicle;

FIG. 2 is a nomograph of a power split mechanism;

FIG. 3 is a nomograph of a transmission;

FIG. 4 is a schematic configuration diagram that shows an engine of the hybrid vehicle;

FIG. 5 is a graph that shows an operation line and an area in which DI ratio r is 100%;

FIG. 6 is a flow chart that shows process executed by an ECU; and

FIG. 7 is a graph that shows a constant power line.

### DETAILED DESCRIPTION OF EMBODIMENTS

Hereinafter, an embodiment of the invention will be described with reference to the accompanying drawings. In the following description, like reference numerals denote the same components. Those names and functions are also the same. Thus, the detailed description thereof is not repeated.

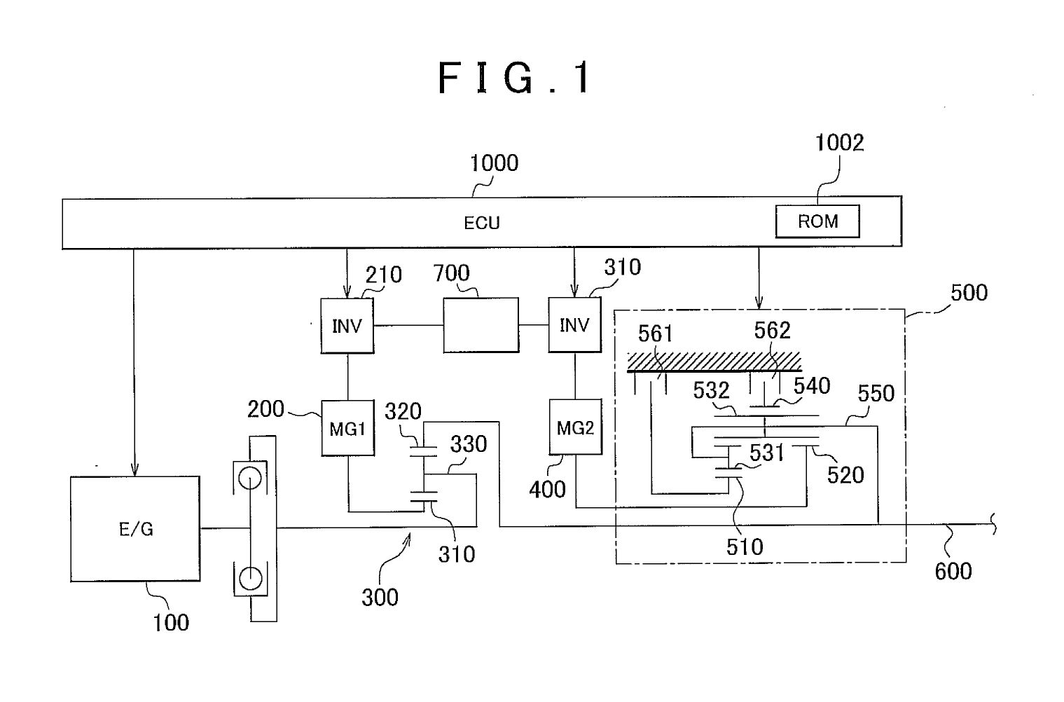

A power train of a hybrid vehicle equipped with a control device according to the present embodiment will be described with reference to FIG. 1. Note that, for example, an electronic control unit (ECU) 1000 executes a program recorded in a read only memory (ROM) 1002 of the ECU 1000 to thereby implement the control device according to the present embodiment.

As shown in FIG. 1, the power train is mainly formed of an engine 100, a first motor generator (MG1) 200, a power split mechanism 300, a second motor generator (MG2) 400 and a transmission 500. The power split mechanism 300 combines or distributes torque between these engine 100 and the MG1 200.

The engine 100 is a general power unit that burns fuel to output power. The operating state, such as the throttle opening degree (intake air volume), the fuel supply amount and the ignition timing, of the engine 100 is electrically controlled. The operating state of the engine 100 is, for example, controlled by the ECU 1000 that is mainly formed of a microcomputer.

The MG1 200 is a three-phase alternating-current rotating electrical machine as an example, and is configured to function as both an electric motor (motor) and a power generator (generator). The MG1 200 is connected to an electrical storage device 700, such as a battery, via an inverter 210. By controlling the inverter 210, the output torque or regenerative torque of the MG1 200 is appropriately set. The inverter 210 is controlled by the ECU 1000. Note that the stator (not shown) of the MG1 200 is fixed and does not rotate.

The power split mechanism 300 is a general gear mechanism that uses a sun gear (S) 310, a ring gear (R) 320 and a carrier (C) 330 as three rotating elements to provide differential action. The sun gear (S) 310 is an external gear. The ring gear (R) 320 is an internal gear and is arranged concentrically with respect to the sun gear (S) 310. The carrier (C) 330 rotatably and revolvably retains pinion gears that are in mesh with these sun gear (S) 310 and the ring gear (R) 320. The output shaft of the engine 100 is coupled to the carrier (C) 330 via a damper. The carrier (C) 330 is the first rotating element. In other words, the carrier (C) 330 serves as an input element.

In contrast to this, the rotor (not shown) of the MG1 200 is coupled to the sun gear (S) 310. The sun gear (S) 310 is the second rotating element. Thus, the sun gear (S) 310 serves as a so-called reaction element, and the ring gear (R) 320 serves as an output element. The ring gear (R) 320 is the third rotating element. Then, the ring gear (R) 320 is coupled to an output shaft 600 that is coupled to drive wheels (not shown).

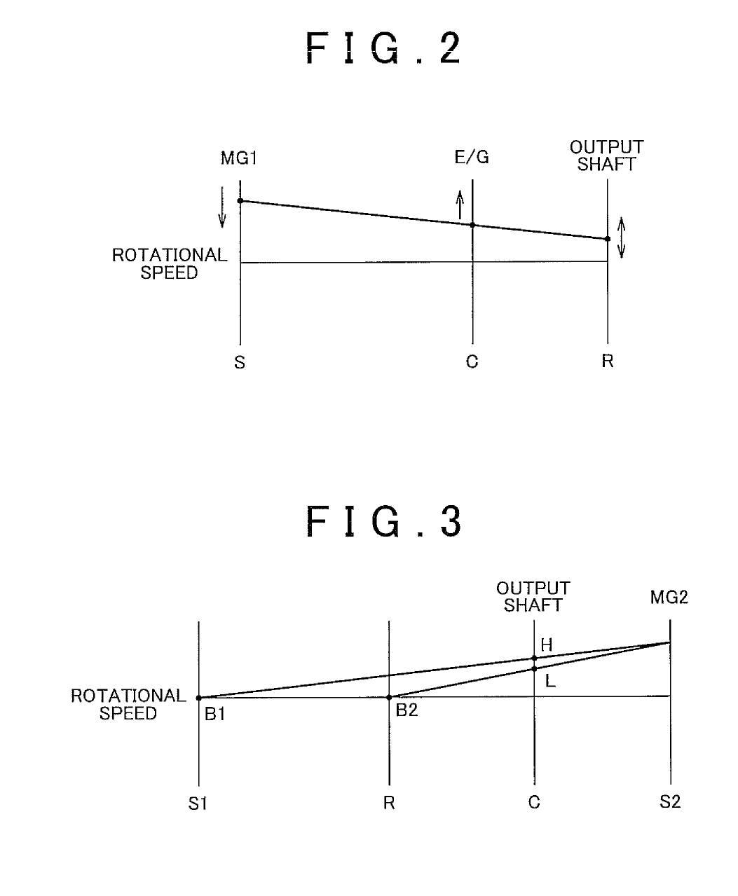

FIG. 2 shows a nomograph of the power split mechanism 300. As shown in FIG. 2, as a reaction torque is input to the sun gear (S) 310 by the MG1 200 with respect to a torque output from the engine 100 and input to the carrier (C) 330, a torque calculated from these torques appears in the ring gear (R) 320 that serves as the output element. In this case, the rotor of the MG1 200 rotates with that torque, and the MCI 200 functions as a power generator. In addition, when the rotational speed of the ring gear (R) 320 (output rotational speed) is constant, the rotational speed of the MG1 200 is increased or decreased to thereby make it possible to continuously (steplessly) vary the rotational speed of the engine 100. That is, the rotational speed of the engine 100 may be, for example, set by controlling the MG1 200 to the rotational speed at which fuel economy is the highest. The MG1 200 is controlled by the ECU 1000.

When the engine 100 is stopped during running, the MG1 200 rotates in the reverse direction. When the MG1 200 is caused to function as an electric motor in that state to output a torque in the forward rotation direction, a torque acts on the engine 100 coupled tb the carrier (C) 330 to rotate the engine 100 in the forward direction to thereby make it possible to start (motor or crank) the engine 100 with the MG1 200. In this case, a torque acts on the output shaft 600 in the direction to stop the rotation of the output shaft 600. Thus, a driving torque for driving the vehicle may be maintained by controlling a torque output from the MG2 400, and, at the same time, it is possible to smoothly start the engine 100. Note that a hybrid model of this type is called mechanical distribution type or split type.

Referring back to FIG. 1, the MG2 400 is a three-phase alternating-current rotating electrical machine as an example, and is configured to function as both an electric motor and a power generator. The MG2 400 is connected to the electrical storage device 700, such as a battery, via an inverter 310. The MG2 400 is configured such that the inverter 310 is controlled to control power running, regeneration and a torque in the case of each of power running and regeneration. Note that the stator (not shown) of the MG2 400 is fixed and does not rotate.

The transmission 500 is formed of a set of Ravigneaux-type planetary gear mechanism. The Ravigneaux-type planetary gear mechanism includes a first sun gear (S1) 510 and a second sun gear (S2) 520. The first sun gear (S1) 510 is an external gear. The second sun gear (S2) 520 is an external gear. First pinions 531 are in mesh with the first sun gear (S1) 510, the first pinions 531 are in mesh with second pinions 532, and the second pinions 532 are in mesh with a ring gear (R) 540. The ring gear (R) 540 is arranged concentrically with the sun gears 510 and 520.

Note that the pinions 531 and 532 are rotatably and revolvably retained by a carrier (C) 550. In addition, the second sun gear (S2) 520 is in mesh with the second pinions 532. Thus, the first sun gear (S1) 510 and the ring gear (R) 540 constitute a mechanism that corresponds to a double-pinion-type planetary gear mechanism together with the pinions 531 and 532. In addition, the second sun gear (S2) 520 and the ring gear (R) 540 constitute a mechanism that corresponds to a single-pinion-type planetary gear mechanism together with the second pinions 532.

Furthermore, the transmission 500 includes a B1 brake 561 and a B2 brake 562. The B1 brake 561 selectively fixes the first sun gear (S1) 510. The B2 brake 562 selectively fixes the ring gear (R) 540. These brakes 561 and 562 are so-called friction engagement elements that generate engaging force using friction force, and may employ a multi-disc-type engaging device or a band-type engaging device. Then, these brakes 561 and 562 are configured such that the torque capacity continuously varies with engaging force resulting from hydraulic pressure. Furthermore, the above described MG2 400 is coupled to the second sun gear (S2) 520. The carrier (C) 550 is coupled to the output shaft 600.

In the above transmission 500, the second sun gear (S2) 520 is a so-called input element, the carrier (C) 550 is an output element, and the B1 brake 561 is engaged to set a high-speed gear of which the speed ratio is larger than “1”. The B2 brake 562 is engaged instead of the B1 brake 561 to thereby set a low-speed gear of which the speed ratio is larger than that of the high-speed gear.

Gear shift between the gears is carried out on the basis of a running state, such as a vehicle speed and a required driving force (or accelerator operation amount). More specifically, gear regions are defined as a map (shift line map) in advance, and then control is executed so as to set any one of the gears on the basis of the detected operating state.

FIG. 3 shows a nomograph of the transmission 500. As shown in FIG. 3, when the B2 brake 562 fixes the ring gear (R) 540, the low-speed gear L is set, and the torque output from the MG2 400 is increased in accordance with the speed ratio and is added to the output shaft 600. In contrast to this, when the B1 brake 561 fixes the first sun gear (S1) 510, the high-speed gear H that is smaller in speed ratio than the low-speed gear L is set. The speed ratio at the high-speed gear H is also larger than “1”, so the torque output from the MG2 400 is increased in accordance with the speed ratio and is added to the output shaft 600.

Note that, in a state where any one of the gears L and H is steadily set, the torque added to the output shaft 600 is a torque that is increased from the output torque of the MG2 400 in accordance with the speed ratio, and is a torque that has received the influence of inertia torque, and the like, resulting from a variation in torque capacity and rotational speed in the any one of the brakes 561 and 562 in a shift transitional state. In addition, the torque added to the output shaft 600 is a positive torque in a driving state of the MG2 400 and is a negative torque in a driven state of the MG2 400.

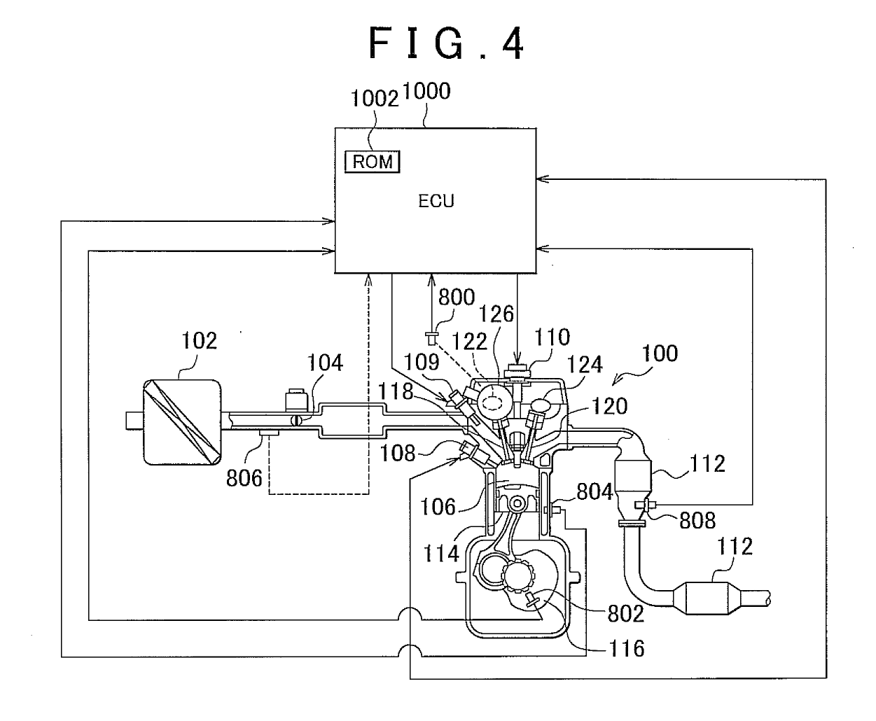

The engine 100 will be further described with reference to FIG. 4. Air is taken into the engine 100 from an air cleaner 102. The intake air volume is adjusted by a throttle valve 104. The throttle valve 104 is an electronic throttle valve that is driven by a motor.

A plurality of cylinders 106 are provided in the engine 100. In each of the cylinders 106, air and fuel are mixed. Fuel is directly injected from a direct injector 108 into a corresponding one of the cylinders 106. That is, the injection hole of each direct injector 108 is provided in a corresponding one of the cylinders 106.

Port injectors 109 are provided for the engine 100 in addition to the direct injectors 108. Each port injector 109 injects fuel into a corresponding one of intake ports. The direct injector 108 and the port injector 109 are provided in correspondence with each cylinder 106.

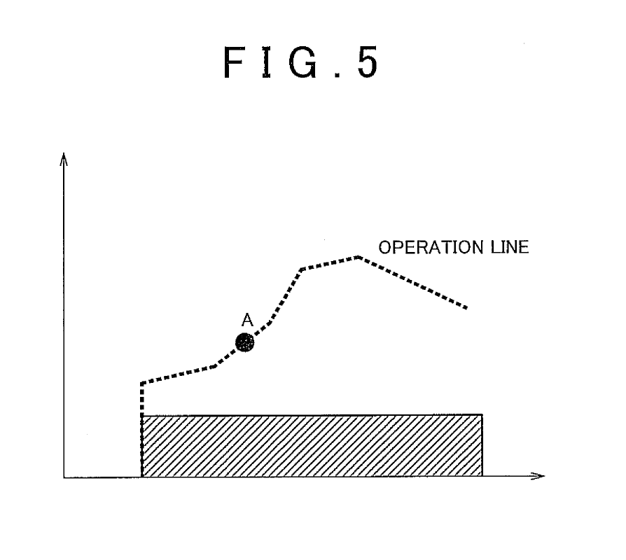

The ratio of a fuel injection amount from the direct injectors 108 with respect to a total injection amount of the fuel injection amount from the direct injectors 108 and a fuel injection amount from the port injectors 109 (hereinafter, also referred to as DI ratio r) is set on the basis of the load and rotational speed of the engine 100. For example, in the diagonally shaded area in FIG. 5, the DI ratio r is set at 100%. That is, in the diagonally shaded area in FIG. 5, fuel is injected from only each direct injector 108, and fuel injection from each port injector 109 is stopped.

In the area other than the diagonally shaded area, the DI ratio r is set so as to be higher than or equal to 0% and lower than or equal to 100%. For example, at the operating point A in FIG. 5, the DI ratio r is set so as to be higher than 0% and lower than 100%. As a result, at the operating point A, fuel is injected from both of each direct injector 108 and each port injector 109.

The broken line in FIG. 5 indicates the operation line of the engine 100. During normal times, the engine 100 is controlled such that the operating point (the load and the rotational speed) of the engine 100 moves along the operation line.

Referring back to FIG. 4, air-fuel mixture in each cylinder 106 is ignited by a corresponding ignition plug 110 to combust. Combusted air-fuel mixture, that is, exhaust gas, is purified by a three-way catalyst 112 and is then emitted outside the vehicle. A piston 114 is pushed down through combustion of air-fuel mixture to rotate a crankshaft 116.

An intake valve 118 and an exhaust valve 120 are provided at the head of each cylinder 106. The volume of air introduced into each cylinder 106 and the timing at which air is introduced into each cylinder 106 are controlled by a corresponding one of the intake valves 118. The volume of exhaust gas emitted from each cylinder 106 and the timing at which exhaust gas is emitted from each cylinder 106 are controlled by a corresponding one of the exhaust valves 120. Each intake valve 118 is driven by a corresponding cam 122. Each exhaust valve 120 is driven by a corresponding cam 124.

The open/close timing (phase) of the intake valves 118 is varied by a VVT mechanism 126. Note that the open/close timing of the exhaust valves 120 may be configured to be varied.

In the present embodiment, a camshaft (not shown) having the cams 122 is rotated by the VVT mechanism 126 to thereby control the open/close timing of the intake valves 118. Note that a method of controlling the open/close timing of the intake valves 118 is not limited to this configuration. In the present embodiment, the VVT mechanism 126 is operated by hydraulic pressure.

The engine 100 is controlled by the ECU 1000. The ECU 1000 controls the throttle opening degree, the ignition timing, the fuel injection timing, the fuel injection amount and the open/close timing of the intake valves 118 such that the engine 100 is placed in a desired operating state. Signals from a cam angle sensor 800, a crank angle sensor 802, a coolant temperature sensor 804, an air flow meter 806 and an air-fuel ratio sensor 808 are input to the ECU 1000.

The cam angle sensor 800 outputs a signal that indicates the cam positions. The crank angle sensor 802 outputs a signal that indicates the rotational speed NE of the crankshaft 116 (engine rotational speed) and the rotation angle of the crankshaft 116. The coolant temperature sensor 804 outputs a signal that indicates the temperature of coolant (hereinafter, also referred to as coolant temperature) of the engine 100. The air flow meter 806 outputs a signal that indicates the air volume taken into the engine 100. The air-fuel ratio sensor 808 detects the air-fuel ratio on the basis of the oxygen concentration in exhaust gas. Note that an O₂ sensor may be used as the air-fuel ratio sensor 808.

The ECU 1000 controls the engine 100 on the basis of the signals input from these sensors and the map and program stored in the ROM 1002.

The ECU 1000 executes air-fuel ratio feedback control for increasing or reducing the fuel injection amount so as to bring the air-fuel ratio close to a target air-fuel ratio. For example, when the air-fuel ratio is higher (leaner) than the target air-fuel ratio, the fuel injection amount is increased. On the other hand, when the air-fuel ratio is lower (richer) than the target air-fuel ratio, the fuel injection amount is reduced.

In addition, the ECU 1000 detects an imbalance abnormality in air-fuel ratio among the cylinders 106. For example, when the width of fluctuations in air-fuel ratio is larger than a threshold, it is determined that there is an imbalance in air-fuel ratio among the cylinders 106. Other than the above, the ECU 1000 may be configured to detect an imbalance abnormality from the width of fluctuations in the rotational speed of the engine 100. A method of detecting an imbalance abnormality may employ a generally known method, so the detailed description of the method is not repeated here.

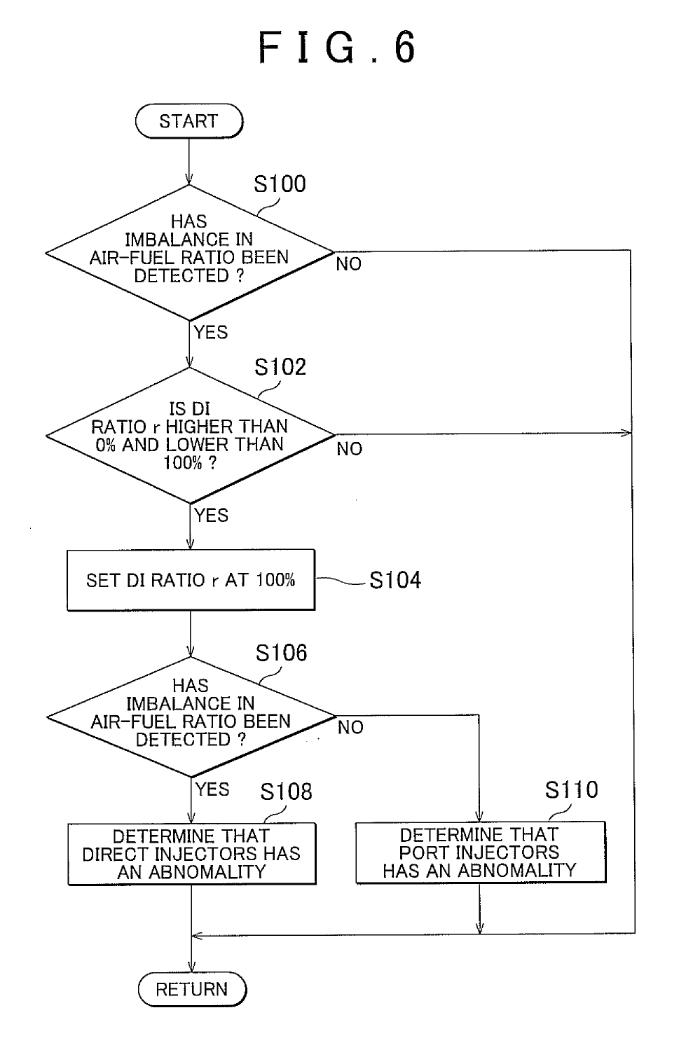

The process executed by the ECU 1000 in the present embodiment will be described with reference to FIG. 6.

In step (hereinafter, step is abbreviated as S) 100, it is determined whether an imbalance abnormality in air-fuel ratio is detected. That is, it is determined whether an imbalance in air-fuel ratio among the cylinders 106 is detected.

When an imbalance abnormality is detected (YES in S100), it is determined in S102 whether the DI ratio r is higher than 0% and lower than 100%. That is, it is determined whether fuel is injected from both of each direct injector 108 and each port injector 109.

When the DI ratio r is higher than 0% and lower than 100% (YES in S102), fuel is injected from only any one of each direct injector 108 and each port injector 109 in S104, and fuel injection from the other one of each direct injector 108 and each port injector 109 is stopped.

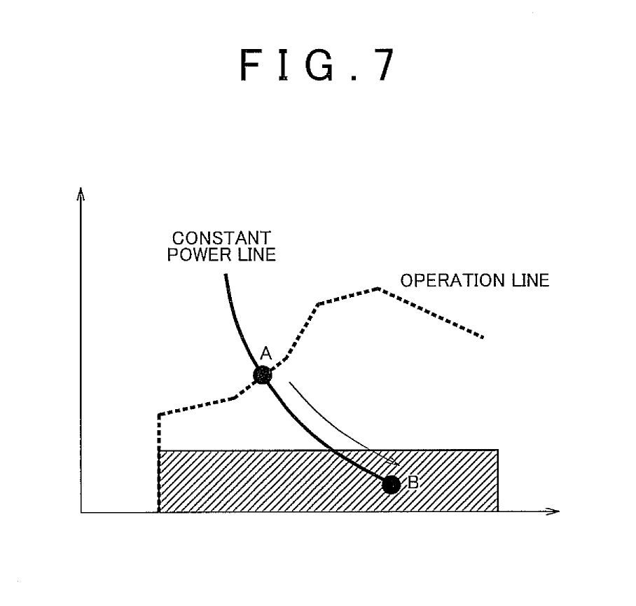

For example, as shown in FIG. 7, the engine 100 is controlled such that the operating point moves along a constant power line to the area that is set such that the DI ratio r is 100%. By so doing, while the output power of the engine is maintained, the operating point is varied from the operating point A at which fuel is injected from both of each direct injector 108 and each port injector 109 to the operating point B at which fuel is injected from only each direct injector 108.

Note that the operating point may be varied from the operating point A at which fuel is injected from both of each direct injector 108 and each port injector 109 to the operating point at which fuel is injected from only each port injector 109.

In addition, the area that is set such that the DI ratio r is 100% is not limited to a low-load area. The area in which the DI ratio r is 100% is appropriately set by a developer where appropriate.

Referring back to FIG. 6, it is determined in S106 whether, in a state where fuel is injected from only each direct injector 108, an imbalance abnormality, that is, an imbalance in air-fuel ratio among the cylinders 106, is detected.

When an imbalance in air-fuel ratio among the cylinders 106 is detected (YES in S106), it is determined in S108 that the direct injectors 108 have an abnormality. On the other hand, when an imbalance in air-fuel ratio among the cylinders 106 is not detected (NO in S106), it is determined in S110 that the port injectors 109 have an abnormality.

Note that, in the case where the operating point is varied from the operating point A at which fuel is injected from both of each direct injector 108 and each port injector 109 to the operating point at which fuel is injected from only each port injector 109, when an imbalance in air-fuel ratio among the cylinders 106 is detected in S106 (YES in S106), it is determined that the port injectors 109 have an abnormality; whereas, when an imbalance in air-fuel ratio among the cylinders 106 is not detected (NO in S106), it is determined that the direct injectors 108 have an abnormality.

The embodiment described above should be regarded as only illustrative in every respect and not restrictive. The scope of the invention is defined by the appended claims rather than the above description. The scope of the invention is intended to encompass all modifications within the meaning and scope of the appended claims and equivalents thereof.

What is claimed is:

1. A control device for an internal combustion engine in which a direct injector that directly injects fuel into a corresponding one of a plurality of cylinders and a port injector that injects fuel into an intake port are both provided on each of the plurality of cylinders, the control device comprising:
a control unit that controls a fuel injection amount from the direct injectors and the port injectors; and
an imbalance detecting unit that, in a state where fuel is injected from both of the direct injectors and port injectors, detects an imbalance in air-fuel ratio among the plurality of cylinders,
wherein when the imbalance in air-fuel ratio is detected by the imbalance detecting unit, the control unit controls the fuel injection amount from the direct injectors and the port injectors such that fuel is injected from one of the direct injectors and the port injectors.

2. The control device according to claim 1, wherein, when the imbalance in air-fuel ratio is detected by the imbalance detecting unit, the control unit controls the fuel injection amount from the direct injectors and the port injectors such that fuel is injected from only the direct injectors.

3. The control device according to claim 1, wherein:
the control unit determines the ratio of a fuel injection amount from the direct injectors and a fuel injection amount from the port injectors on the basis of a load and rotational speed of the internal combustion engine; and
when the imbalance in air-fuel ratio is detected by the imbalance detecting unit, the control unit varies the ratio in fuel injection amount from the ratio in fuel injection amount in the case where fuel is injected from both of the direct injectors and the port injectors to the ratio in fuel injection amount in the case where fuel is injected from one of the direct injectors and the port injectors while maintaining the output power of the internal combustion engine.

4. The control device according to claim 3, wherein, when the imbalance in air-fuel ratio is detected by the imbalance detecting unit, the control unit varies the ratio in fuel injection amount such that fuel is injected from only the direct injectors.

5. The control device according to claim 4, further comprising an abnormality determining unit that, in the case where fuel is injected from only the direct injectors, determines that the direct injectors have an abnormality when the imbalance in air-fuel ratio among the plurality of cylinders is detected and determines that the port injectors have an abnormality when the imbalance in air-fuel ratio among the plurality of cylinders is not detected.

6. The control device according to claim 3, wherein, when the imbalance in air-fuel ratio is detected by the imbalance detecting unit, the control unit varies the ratio in fuel injection amount such that fuel is injected from only the port injectors.

7. The control device according to claim 6, further comprising an abnormality determining unit that, in the case where fuel is injected from the each port injectors, determines that the port injectors have an abnormality when the imbalance in air-fuel ratio among the plurality of cylinders is detected and determines that the direct injectors have an abnormality when the imbalance in air-fuel ratio among the plurality of cylinders is not detected.

8. The control device according to claim 1, wherein the internal combustion engine is mounted as a driving source on a vehicle on which an electric motor is mounted.

9. A control method for an internal combustion engine in which a direct injector that directly injects fuel into a corresponding one of a plurality of cylinders and a port injector that injects fuel into an intake port are both provided on each of the plurality of cylinders, the control method comprising:
in a state where fuel is injected from both of the direct injectors and the port injectors, detecting an imbalance in air-fuel ratio among the plurality of cylinders; and
when the imbalance in air-fuel ratio is detected, controlling a fuel injection amount from the direct injectors and the port injectors such that fuel is injected from one of the direct injectors and the port injectors.
